(19) United States
(12) Patent Application Publication
(10) Pub. No.: US 2006/0065109 A1
(43) Pub. Date: Mar. 30, 2006

(54) Electric note bending by neck movement of stringed instrument

(76) Inventor: Gorgos M. Zigounakis, Inverness, CA (US)

Correspondence Address: Gorgos M. Zigounakis, P.O. Box 586, Inverness, CA, 94937, US

(21) Appl. No.: 11/241,451

(22) Filed: Sep. 29, 2005

Related U.S. Application Data
(60) Provisional application No. 60/615,522, filed on Sep. 30, 2004.

(51) Int. Cl. G10H 1/02

(52) U.S. Cl. 84/737

(57) ABSTRACT

An improved stringed musical instrument (10) with a neck (12) which can be moved relative to the body (11), yet leaving the action of the strings (16) uncompromised. This movement (M) adjusts an electronic control (36) to vary a variety of effects commonly used in modern music. The operation leaves the musician's feet, hands, and fingers free to play in all other normal manners.

### CROSS-REFERENCES TO RELATED APPLICATIONS

This application claims priority of my Provisional Patent Application, Ser. No. 60/615,522, Filed Sep. 30, 2004.

### BACKGROUND

1. Field of Invention

This invention relates to electrically enhanced musical instruments, specifically those with strings.

2. Description of Prior Art

Musicians commonly look for new sounds and combinations of sounds to enhance their pieces, in addition to perfecting the execution of the pieces they perform. A classical enhancement has been to stretch the strings of a stringed instrument, such as a guitar, which results in higher pitches of the sounds when the strings are vibrated. The sounds produced by such stretching are not normally produced notes, so musicians refer to this process as “bending” notes.

With the advance of electric musical instruments, the field of sound enhancement has expanded to include changes in tone, volume, wah, wammy, delay, echo, decay, intonation, overdrive, distortion, dimensional processing, etc. I will refer to all these enhancements, and those that have yet to be developed, as “effects”. The effects are now usually electronically produced, and if complex they may require a unit commonly referred to as an “effects processor”, which may be built into the instrument or may be a separate unit with which the instrument is in communication.

The control of any effect is done by an electrical controlling device such as a potentiometer. Sometimes these devices are built into modern-electric instruments in the form of knobs, levers, switches, bars, slides, etc. These need to be operated by one of the hands, but this is problematic since the hands are normally used on the strings. Sometimes effects are also controlled through a host of foot pedals and similar devices which the musician operates while using both hands to play the instrument. Many effects are made by the musician actually turning away and operating controls or even rubbing the instrument on the amplifier or processing units while playing.

An effect which requires the musician to use a hand is less than ideal because the performer loses the ability of that hand to continue playing the strings. By the same token, an effect which limits the musician to remain near foot controls (or worse yet, facing an amplifier) does not allow the artist the freedom to move in relation to other musicians or into the audience, which is one reason that today's new music is so dynamic.

The neck of a stringed musical instrument is usually, but not always, rigidly attached to the body of the instrument. U.S. Pat. No. 1,747,650 to Sawyer (1930), U.S. Pat. No. 1,755,019 to Parker (1930), and U.S. Pat. No. 4,616,550 to Lacroix (1984) all propose a neck which is either flexible or hinged at the instrument body. The problem with these arrangements is that they change the height (or action) of the strings above the finger board because they vary the angle of the neck and body from a common longitudinal plane. U.S. Pat. No. 3,447,412 to Marshall (1969) proposes a guitar which does this and is also capable of a “rotary displacement” of the parts. Assuming that the angular displacement of Marshall's device could be controlled, the pivot mentioned would still have to be very slight in order to not compromise the action, resulting in a very subtle change of sound.

The action of a stringed musical instrument is so important that many patents have been issued just for the purpose of controlling it. U.S. Pat. No. 1,671,942 to Strupe (1928), U.S. Pat. No. 1,707,192 to Overton (1929), U.S. Pat. No. 1,785,266 to Lange (1930), U.S. Pat. No. 5,679,910 to Steinberger et al. (1997), U.S. Pat. No. 5,965,830 to Carlson (1999), and U.S. Pat. No. 6,198,030 B1 to Rose (2001) all address this problem. These adjustments and such are all of a semi-permanent nature and are not used during play.

Many pivotal adjustments of the neck of a stringed instrument which do not change the angle to the body and therefore the action have been proposed. U.S. Pat. No. 5,390,578 to Raymer (1995) concerns rotating the neck, of a guitar into the body for storage purposes. U.S. Pat. No. 5,994,633 to Norton (1999) also pivots the neck relative to the body to facilitate storage but it also may be locked into a position askew to the plane of the body to the taste and comfort of the player. U.S. Pat. No. 4,534,260 to Burrell (1985), U.S. Pat. No. 5,852,249 to Steinberg et al. (1998), and U.S. Pat. No. 6,034,308 to Little (2000), also address the issue of skew; but all these devices concern the alignment being fixed permanently or a least not during the course of play. U.S. Pat. No. 4,981,063 to Roberts (1991) appears to be a multitude of guitar necks which can pivot into position as the instrument is played. However, Roberts actually shows four individual instruments, each complete with its own bridge and pick up (usually found on the body of the instrument). The pivoting brings a different instrument into play, rather than changing the sound of the instrument in play.

My U.S. Pat. No. 6,657,112 (2003) pivots the neck of a stringed instrument in relation to the body, but there is the possibility that during such pivotong the action of the instrument will be compromised, introducing the problems referred to above. Though my previous device uses string-stretching to achieve a degree of acoustic note bending, the variable action resulting from the neck and nut twisting independent of the bridge makes the instrument somewhat more difficult to play.

### ADVANTAGES

Accordingly, the present invention has one or more of the following advantages:
(a) to provide an improved stringed instrument and method of changing the effects that it produces;
(b) to provide a method of varying any electrically produced effect on a stringed musical instrument by slightly pivoting, rotating, twisting, or in any way moving the neck in relationship to the body;
(c) to provide a method of producing the above mentioned effects while allowing one hand to freely select and change notes and chords on the finger board of a stringed musical instrument;
(d) to provide a method of producing the above mentioned effects while allowing one hand to freely strum, pick, pluck, bow, or in any way vibrate the strings of the musical instrument; and
(e) to provide a method of producing the above mentioned effects with a stringed musical instrument that allows the player more freedom to move about on the floor or stage.

Further advantages are to provide a stringed musical instrument which is simpler to use and less expensive to manufacture, and which can be produced in mass or individually. Still further objects and advantages will become apparent from consideration of the ensuing description and drawings.

### DRAWING FIGURES

In the drawings, closely related figures have the same number but different alphabetic suffixes.

FIG. 1 shows a perspective view of a neck bending device according to my invention used on a typical stringed musical instrument, an electric guitar.

FIGS. 2A, 2B, and 2C show three different positions which the neck of the instrument may be moved (pivoted in this case) in relation to the body, as seen from the direction indicated by lines 2-2 in FIG. 1.

FIG. 3 shows a detailed section view of the connecting mechanism as seen from the direction indicated by lines 3-3 in FIG. 2B.

FIG. 4 is a detail of the area where the neck can be temporarily locked to the body of the guitar shown in FIG. 1.

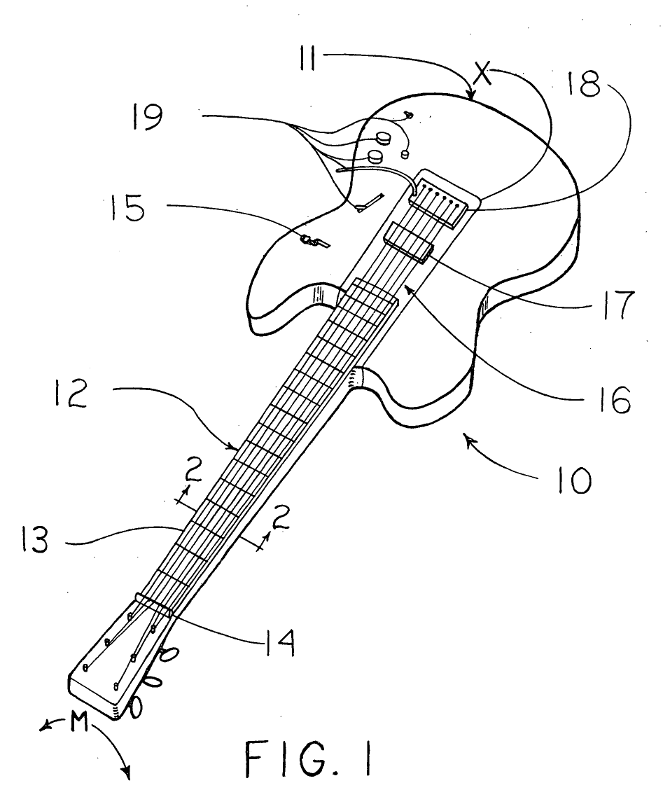

### DETAILED DESCRIPTION—FIGS. 1 TO 4

A typical embodiment of a guitar that a player can use to produce electric note bending by neck movement according to the present invention is illustrated in FIG. 1. An electric guitar 10 is made of two parts; a body 11, and a neck 12. A plurality of strings 16 stretch from a nut 14, across the finger board 13, and terminate at a bridge 18. A pickup or microphone (and an associated amplifier—not shown) 17 aids in the electrical enhancement of the string vibration. A plurality (six in this figure) of controls 19 are available to produce a variety of effects. (Only the knobs, levers, buttons, etc. are shown on this or any instrument; the actual controls are always recessed into the body of the instrument and covered by a protective plate.)

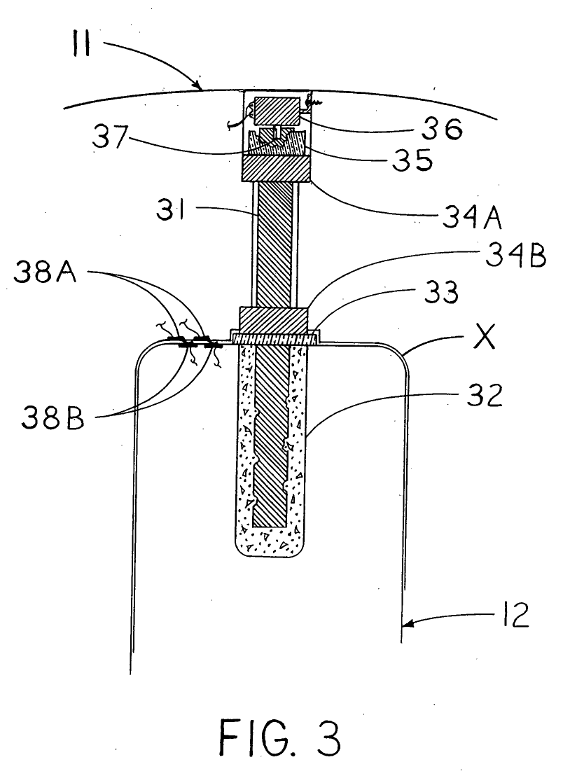

Neck 12 is able to move (pivot in this case) in relation to the body, as indicated at M. A movement-locking lever 15 is provided to keep the neck in a normal or neutral position when note bending effects are not desired. A corner of neck 12 is marked in this figure at X and again in FIG. 3 to serve as a reference point.

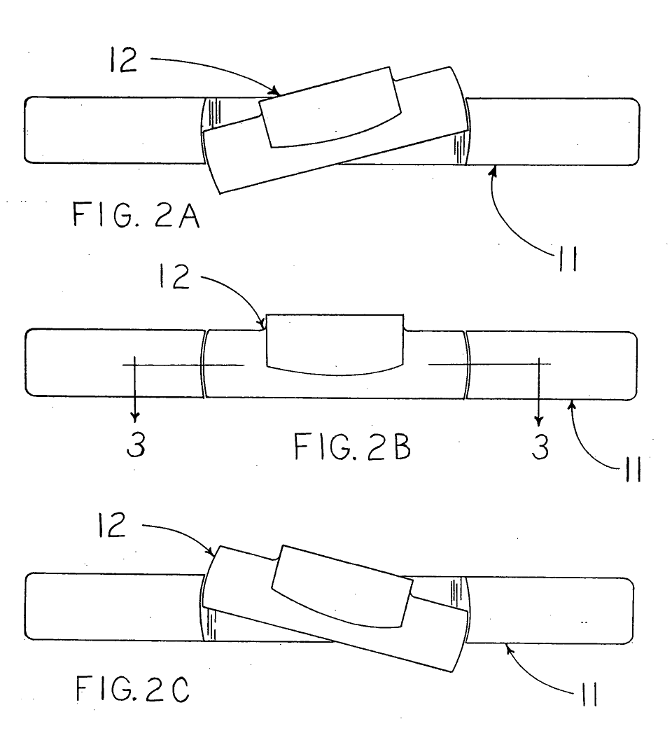

FIGS. 2A, 2B, and 2C show a view taken as indicated by section lines 2-2, of FIG. 1. In FIG. 2A neck 12 is pivoted to a counter-clockwise position relative to body 11, which would result in either a minimal or an extreme effect. (The controller 36, shown in FIG. 3, could either deliver minimum values at a counter-clockwise position, mid-range at 12 o'clock, and maximum values at a clockwise position; or maximum values at counter-clockwise position, minimum values at 12 o'clock, and maximun again at the clockwise position.) In FIG. 2B the neck is in the normal or neutral position, which would result in either a mid-range or minimal effect. In FIG. 2C the neck is rotated to a clockwise position, which would result in an extreme effect. (Or vise versa, or other combinations could result from selecting different controllers at the option of the musician or instrument maker.)

FIG. 3 is a view taken as indicated by section lines 3-3 in FIG. 2B showing the detail of the mechanism that allows the controlled pivoting. Corner X is the same as that shown in FIG. 1 for purpose of reference. A strong and true pin or stud 31 passes from neck 12 through a cavity in body 11. The pin is permanently fixed to the neck with a bonding matrix 32, making it an extension of the neck. A thrust bearing 33 insures that the neck and body can pivot freely in relation to each other.

Ball bearings 34A and 34B are press fit into the body and also insure that the pin can pivot freely. A collar 35 locks the pin against the adjoining ball bearing so that the neck cannot pull away from the body.

A controller 36 is shown attached to the body. This device may be a potentiometer like one of controls 19 (FIG. 1) built into the instrument, or it may be any device or microprocessor which results in varying effects, whether on the instrument or in communication (hard wired or remote controlled) with a separate effects processor. Wires lead from controller 36 into the cavity (not shown) inside the instrument mentioned in FIG. 1 where electronic circuitry (also not shown, but well known in the art) is provided.

A cut-out in collar 35 shows where shaft 37 of controller 36 is keyed to pin 31, such that any pivot of the neck causes controller 36 to rotate, changing its electric resistance (or any other electrical characteristic if controller 36 is other than a potentiometer. Electric impulses from pick-up 17 (or any other device on the neck assembly) are wired to the mating parts of a rotary electrical connector 38A and 38B so that the impulses can be transferred to the cavity inside the instrument while pivoting occurs. (Two lead wires are shown in this diagram, but any number can be used.)

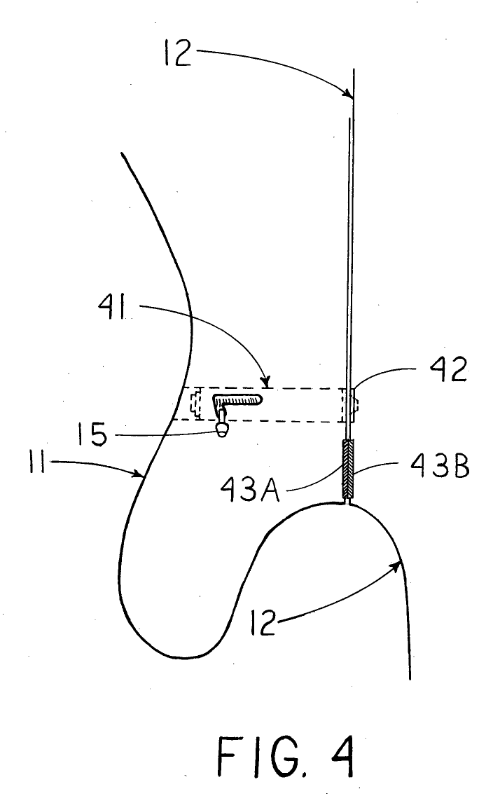

FIG. 4 shows a spring-loaded bullet catch assembly 41 recessed into body 11 of the instrument. A cylindrical or curved strike plate 42 with a recessed cone or hole is installed in neck 12. When it is desired that the instrument be locked in the neutral position, the bullet of the catch assembly extends into the recessed cone or hole of plate 42 so as to lock the neck and body to each other. (There may also be positions other that neutral where the locking mechanism may be engaged.)

Locking lever 15 is seen in the retracted position (where the bullet is not in the recessed cone or hole), so that the neck and body are free to pivot in relation to each other. Bearing surfaces 43A and 43B are recessed into the body and neck, respectively, to assure smooth and free motion at this point which is far from main pivoting bearings 34A and 34B.

### Operation—FIGS. 1 to 4

The manner of using the neck moving electric stringed musical instrument to achieve note bending effects is similar to using a conventional stringed musical instrument. Assume that the neck of instrument 10 is in the neutral or normal position as shown in FIG. 2B. The musician may or may not engage the neck movement locking lever 15 (FIGS. 1 and 4). If the instrument or effects processor is equipped with a variety of effects the musician will select and engage the desired one so that controller 36 (FIG. 3) will regulate that effect. The performer will then proceed to play the instrument in the manner in which those skilled in the art normally do.

When the musician or artist comes to a part where bending a note or chord or any of the possible effects is desired, they will (after releasing the locking catch, if it has been engaged) rotate neck 12 (FIG. 1) in the manner illustrated by M in FIG. 1, using wrist action of the hand (usually left) that holds the neck and depresses the strings. This is easy to do and the user can do this while depressing the strings. The artist may pivot the neck to the position shown in FIG. 2A, or to the position shown in FIG. 2C, or may oscillate between them or any combination of these actions at any speed or pattern to suit their purpose. This will result in the electric controlling device (controller) directly making a desired effect or indirectly controlling an effect from an effects processor, whether the processing unit is within the instrument or independent and in communication with the instrument. During this pivoting operation the artist will have both hands and both feet free to further enhance the music with whatever other effects or showmanship they may normally use. At conclusion of this action, the musician can return to conventional play by simply returning the neck to the neutral, or normal, or rest position shown in FIG. 2B and either lock or not lock the neck in place.

For example, in one embodiment, controller 36 may be arranged to vary an echo effect when the neck is pivoted. Thus when the musician desires, and at an appropriate place in a musical selection, they can walk over to the pianist, unlock the catch and rotate the neck in a pattern that suits the harmonic situation that presents itself, causing the notes being played to echo in a way complimentary to the piano work. When the musician no longer desires this effect, they may return the neck to the neutral position (FIG. 2B) and optionally re-engage the catch. They may then continue to play in this mode and walk over to an effects processor, where they will select a different effect for controller 36, then walk into the audience and use the neck pivoting action to control a wah effect. Later the musician may select a tone effect and play that with the now possible wrist action while in close proximity to the rhythm guitarist. All the while, never having to stop addressing the strings with all fingers.

### CONCLUSION, RAMIFICATIONS, AND SCOPE

Accordingly, the reader will see that the electric sound bending or effects by neck movement of an instrument can be used to achieve results which are highly coveted in the field of music, without compromising the ability of the musician to play the strings. The effect, for example, may be a shift of tone, a wah, an echo, etc. Furthermore, this neck movement innovation has the additional advantage that it permits a musician to make these effects with a rarely before used action which can augment all previous methods for achieving these effects, resulting in combinations and innovations of sounds never before possible. The effort to realize effects is easy, since it is electrically enhanced. The motion leaves one hand free to select and change notes and chords and the other hand free to strum, pick, pluck, bow, or in any other way vibrate the strings. The musician is free to move about to any location on the floor or stage while actively playing.

Although the description above contains many specificities, these should not be construed as limiting the scope of the invention but as merely providing illustrations of some of the presently preferred embodiments of this invention. For example, the controller operated by the motion can be used to produce effects other than sound, such as visual effects, e.g., light shows, etc. The neck can alternately be moved angularly in respect to the body, rather than pivotably. The movement of the neck can be sensed by an optical sensor, analogous to a mouse trackball, rather than a potentiometer.

Thus the scope of the invention should be determined by the appended claims and their legal equivalents, rather than by the examples given.

I claim:

1. A stringed musical instrument comprising:
(a) a neck section, and
(b) a body section,
(c) said neck and body sections being joined together such that they may be moved in relation to each other without compromising the ability to play said instrument, and
(d) an electric device disposed such that movement of said neck and body sections in relation to each other will result in electrical changes of said electric device, said electrical changes being arranged to vary the effects produced by said instrument,
whereby the effects produced by said instrument may be changed by moving said neck and body sections while playing said instrument.

2. The stringed musical instrument of claim 1 wherein said neck and body are arranged to pivot with each other.

3. The stringed musical instrument of claim 1 wherein said electric device is a potentiometer controlling an effects processor.

4. The stringed musical instrument of claim 1 wherein said electrical device is a microprocessor directly controlling effects.

5. The stringed musical instrument of claim 1, further including a locking device for selectively preventing said neck and body sections from moving in relation to each other.

6. The stringed musical instrument of claim 2 where said neck and body are arranged to pivot with each other, said neck comprising an elongated member containing a plurality of strings extending therealong, an end of said neck distant from said body having a plurality of string-tightening devices, the opposite end of said neck terminating in said body section and being pivotably journaled in said body section.

7. The stringed musical instrument of claim 2 where said neck and body are arranged to pivot with each other, said pivoting being accomplished by a true and strong pin extending from the neck section and traversing a plurality of bearings contained in the body section, with additional bearings placed at intervals along the neck and body sections as required to ensure smooth and true pivoting.

8. A stringed musical instrument comprising:
(a) an upper section, and
(b) a lower section,
(c) said upper and lower sections being joined together such that they may be moved in relation to each other without compromising the ability to play said instrument, and
(d) an electrical device disposed such that movement of said upper and lower sections in relation to each other will result in electrical changes of said electric device, said electrical changes being arranged to vary the effects produced by said instrument,
whereby the effects produced by said instrument may be changed by moving said upper and lower sections while playing said instrument.

9. The stringed musical instrument of claim 8 wherein said upper and lower sections are arranged to pivot with each other.

10. The stringed musical instrument of claim 8 wherein said electric device is a potentiometer controlling an effects processor.

11. The stringed musical instrument of claim 8 wherein said electrical device is a microprocessor directly controlling effects.

12. The stringed musical instrument of claim 8, further including a locking device for selectively preventing said upper and lower sections from moving in relation to each other.

13. The stringed musical instrument of claim 9 where said upper and lower sections are arranged to pivot with each other, said upper section comprising an elongated member containing a plurality of strings extending therealong, the end of said upper section distant from said lower section having a plurality of string-tightening devices, the opposite end of said upper section terminating in said lower section and being pivotably journaled in said lower section.

14. The stringed musical instrument of claim 9 where said upper and lower sections are arranged to pivot with each other, said pivoting being accomplished by a true and strong pin extending from the upper section and traversing a plurality of bearings contained in the lower section, with additional bearings placed at intervals along the upper and lower sections as required to ensure smooth and true pivoting.

15. A stringed musical instrument comprising:
(a) an active section, containing the strings and electronic pick-ups, and
(b) a support section, to keep the instrument in place on the musician and house various electrical contrivances,
(c) said active and support sections being joined together such that they may be moved in relation to each other without compromising the ability to play said instrument, and
(d) an electrical device disposed such that movement of said active and support sections in relation to each other will result in electrical changes of said electric device, said electrical changes being arranged to vary the effects produced by said instrument,
whereby effects produced by said instrument may be changed by moving said active and support sections while playing said instrument.

16. The stringed musical instrument of claim 15 wherein said active and support sections are arranged to pivot with each other.

17. The stringed musical instrument of claim 15 wherein said electric device is a potentiometer controlling an effects processor.

18. The stringed musical instrument of claim 15 wherein said electrical device is a microprocessor directly controlling effects.

19. The stringed musical instrument of claim 15, further including a locking device for selectively preventing said active and support sections from moving in relation to each other.

20. The stringed musical instrument of claim 16 wherein said active and support sections are arranged to pivot with each other, said active section comprising an elongated member containing a plurality of strings extending therealong, an end of said active section distant from said support section having a plurality of string-tightening devices, the opposite end of said active section terminating in said support section and being pivotably journaled in said support section.
